(19) United States
(12) Patent Application Publication
(10) Pub. No.: US 2023/0095869 A1
(43) Pub. Date: Mar. 30, 2023

(54) VEHICLE CONTROL DEVICE AND METHOD

(71) Applicant: HONDA MOTOR CO., LTD., Tokyo (JP)

(72) Inventor: Morris Kubatzki, OFFENBACH/AM MAIN (DE)

(73) Assignee: HONDA MOTOR CO., LTD., Tokyo (JP)

(21) Appl. No.: 17/862,413

(22) Filed: Jul. 12, 2022

(30) Foreign Application Priority Data
Sep. 26, 2021 (CN) 202111127023.5

(51) Int. Cl. B60W 30/16

(52) U.S. Cl. CPC B60W 30/16; B60W 2754/30; B60W 2554/4041; B60W 2720/106; B60W 2556/10; B60W 2540/10; B60W 2540/12; B60W 2552/30; B60W 2555/60

(57) ABSTRACT

The present disclosure provides a vehicle control device and method. The vehicle control device includes: a vehicle detection part that detects vehicles existing around the driver's vehicle and outputs a detection result; and a control part coupled to the vehicle detection part. The control part includes: a vehicle control part that controls a vehicle distance to a preceding vehicle based on the detection result; and an adaptive part that uses an adaptation algorithm to accelerate/decelerate the driver's vehicle according to the acceleration/deceleration instruction from the driver when the vehicle control part is executing control of the vehicle distance. The adaptive part changes the vehicle acceleration/deceleration characteristic of the driver's vehicle in the control of the vehicle distance based on the history of the acceleration/deceleration instruction.

### CROSS-REFERENCE TO RELATED APPLICATION

This application claims the priority benefit of China application no. 202111127023.5, filed on Sep. 26, 2021. The entirety of the above-mentioned patent application is hereby incorporated by reference herein and made a part of this specification.

### BACKGROUND

### Technical Field

The present disclosure relates to a vehicle control technology, and in particular, to a vehicle control device and method for controlling the driving of a vehicle during the activation of adaptive cruise control (ACC).

### Description of Related Art

The current adaptive cruise control (ACC) may take the place of the driver to actively follow the vehicle ahead, and allow the driver's vehicle to accelerate/decelerate automatically. During the period when ACC is enabled, the driver may adjust the target vehicle distance between the driver's vehicle and the vehicle ahead and the time gap (normally the time gap may be divided into 3 to 5 levels from short to long). Moreover, for some types of vehicles, adjustment may also be made to switch between several predetermined driving modes (e.g. comfort mode, sport mode, etc.). In addition, the cruising speed may also be set by the driver while ACC is enabled, or for some types of vehicles, ACC may also adjust the cruising speed according to the speed limit indicated by traffic signs or regulations.

In recent years, a function of automatically decelerating before making a curve has been added to some types of vehicles to limit the lateral acceleration of the vehicle traveling along the curve.

Conventional technology (US publication 2017/0088128 and US publication 2017/0080942) has disclosed vehicle control methods that may adjust the cruising speed of ACC along a curve. Basically these methods may find out the driving characteristics of the driver and adjust the cruising speed of ACC accordingly.

### SUMMARY

Generally speaking, when driving a vehicle, the driver cannot directly control the vehicle with feedback like the Lane Keep Assist System (LKAS). The driver controls the vehicle indirectly with feedback by paying attention to the acceleration and observing the vehicle distance to the surrounding vehicles (especially the vehicle ahead). Also, different drivers have different preferences for acceleration and vehicle distance in certain situations. As a result, the perception of the vehicle's current conditions perceived by the control device equipped on the vehicle is normally inconsistent with the driver's intentions or preferences. For example, the driver may feel that the vehicle is accelerating too slowly or too fast under ACC control, or that the cruising speed is too high or too low when passing through a curve. Under the circumstances, the driver has to switch frequently between various driving modes and/or target vehicle distances, which causes inconvenience in operation. Especially when the driver feels that the cruising speed is too high, the driver may also feel uneasy and disable auxiliary functions such as ACC, resulting in a decrease in overall driving safety.

In view of the above issues, a purpose of the present disclosure is to provide a vehicle control device and method, which may instantly control the vehicle according to the driver's preference during the ACC activation period, and when the same or similar scenario is encountered again, the vehicle may be automatically controlled by ACC in a way that matches the preferences of the driver.

In order to achieve the purpose, the present disclosure provides a vehicle control device, including: a vehicle detection part that detects vehicles existing around the driver's vehicle and outputs a detection result; and a control part coupled to the vehicle detection part. The control part includes: a vehicle control part that controls a vehicle distance to a preceding vehicle based on the detection result; and an adaptive part that uses an adaptation algorithm to accelerate/decelerate the driver's vehicle according to the acceleration/deceleration instruction from the driver when the vehicle control part is executing control of the vehicle distance. The adaptive part changes the vehicle acceleration/deceleration characteristic of the driver's vehicle in the control of the vehicle distance based on the history of the acceleration/deceleration instructions.

Furthermore, in the present disclosure, the vehicle control device further includes an input part coupled to the control part. The input part includes an accelerator pedal, a brake pedal, and a setting interface. The adaptive part obtains the acceleration/deceleration instruction from the driver according to the change of the position of the accelerator pedal, the change of the position of the brake pedal, or the setting operation received from the setting interface.

Furthermore, in the present disclosure, the vehicle acceleration/deceleration characteristics include a set speed for adaptive cruise control and a target vehicle distance to the preceding vehicle.

Also, in the present disclosure, the adaptive part calculates a preferred acceleration/deceleration characteristic of the driver according to the acceleration/deceleration instruction from the driver, and changes the vehicle acceleration/deceleration characteristic based on the calculated preferred acceleration/deceleration characteristic to accelerate/decelerate the driver's vehicle.

Moreover, in the present disclosure, when the calculated preferred acceleration/deceleration characteristic exceeds a safe range, the adaptive part suspends changing the vehicle acceleration/deceleration characteristic based on the preferred acceleration/deceleration characteristic.

Furthermore, in the present disclosure, the vehicle control device further includes a storage device coupled to the control part and storing a history of the acceleration/deceleration instruction. The history of the acceleration/deceleration instruction includes multiple reference scenarios and multiple reference acceleration/deceleration characteristics respectively associated with the multiple reference scenarios.

Moreover, in the present disclosure, each of the reference scenarios includes one or more of a corner radius parameter, a target vehicle parameter, a speed limit parameter, a road condition parameter, and a lane width parameter.

In addition, in the present disclosure, the control part further includes a scenario detection part that detects a current scenario while the driver's vehicle is driven. The adaptive part compares the current scenario of the driver's vehicle with the plurality of reference scenarios stored in the storage device. When the current scenario matches one of the plurality of reference scenarios, the adaptive part changes the vehicle acceleration/deceleration characteristics of the driver's vehicle in the control of the vehicle distance based on the reference acceleration/deceleration characteristic associated with one of the plurality of reference scenarios.

Furthermore, in the present disclosure, when the current scenario matches one of the multiple reference scenarios, and the adaptive part obtains the acceleration/deceleration instruction from the driver, the adaptive part updates the reference acceleration/deceleration characteristic associated with one of the plurality of reference scenarios according to the acceleration/deceleration instruction from the driver.

Also, in the present disclosure, when the current scenario does not match any one of the plurality of reference scenarios, and the adaptive part obtains the acceleration/deceleration instruction from the driver, the adaptive part calculates the preferred acceleration/deceleration characteristics of the driver according to the acceleration/deceleration instructions from the driver, and stores the current scenario and the preferred acceleration/deceleration characteristic in the storage device as a new reference scenario and a new reference acceleration/deceleration characteristic.

In addition, the present disclosure further provides a vehicle control method, including the following steps: detecting vehicles existing around the driver's vehicle and outputting a detection result; controlling a vehicle distance to a preceding vehicle based on the detection result; using an adaptation algorithm to accelerate/decelerate the driver's vehicle according to the acceleration/deceleration instruction from the driver when executing the control of the vehicle distance; and changing the vehicle acceleration/deceleration characteristic of the driver's vehicle in the control of the vehicle distance based on the history of the acceleration/deceleration instructions.

Moreover, in the present disclosure, the vehicle control method further includes: obtaining the acceleration/deceleration instruction from the driver according to the change of the position of the accelerator pedal, the change of the position of the brake pedal, or the setting operation received from the setting interface.

Further, in the present disclosure, the step of accelerating and decelerating the driver's vehicle according to the acceleration/deceleration instruction from the driver includes: calculating a preferred acceleration/deceleration characteristic of the driver according to the acceleration/deceleration instruction from the driver; and changing the vehicle acceleration/deceleration characteristic based on the calculated preferred acceleration/deceleration characteristic to accelerate/decelerate the driver's vehicle.

Also, in the present disclosure, the vehicle control method further includes a step of: when the calculated preferred acceleration/deceleration characteristic exceeds a safe range, suspending changing the vehicle acceleration/deceleration characteristic based on the preferred acceleration/deceleration characteristic.

Furthermore, in the present disclosure, the vehicle control method further includes storing a history of the acceleration/deceleration instructions.

Moreover, in the present disclosure, the step of changing the acceleration/deceleration characteristic of the driver's vehicle in the control of the vehicle distance based on the history of the acceleration/deceleration instructions includes: detecting a current scenario while the driver's vehicle is driven; comparing the current scenario of the driver's vehicle with the plurality of stored reference scenarios; and when the current scenario matches one of the plurality of reference scenarios, changing the vehicle acceleration/deceleration characteristics of the driver's vehicle in the control of the vehicle distance based on the reference acceleration/deceleration characteristic associated with one of the plurality of reference scenarios.

Furthermore, in the present disclosure, the vehicle control method further includes the step of: when the current scenario matches one of the multiple reference scenarios, and the acceleration/deceleration instruction is obtained from the driver, updating the reference acceleration/deceleration characteristic associated with one of the plurality of reference scenarios according to the acceleration/deceleration instruction from the driver.

Also, in the present disclosure, the vehicle control method further includes a step of: when the current scenario does not match any one of the plurality of reference scenarios, and the acceleration/deceleration instruction is obtained from the driver, calculating the preferred acceleration/deceleration characteristics of the driver according to the acceleration/deceleration instructions from the driver, and storing the current scenario and the preferred acceleration/deceleration characteristic as a new reference scenario and a new reference acceleration/deceleration characteristic.

Based on the above, the vehicle control device and method of the present disclosure may change the vehicle acceleration/deceleration characteristics of the driver's vehicle in a specific scenario based on the history of acceleration/deceleration instructions of the driver during the ACC activation period. In the meantime, the driver may also give acceleration/deceleration instructions, so that the driver's vehicle may accelerate/decelerate in real time under the control of ACC. The driver's preferences are also updated to the storage device for use in the same or similar scenario encountered next time. Since the control method of the vehicle control device of the present disclosure will be very similar (or even the same) as the driver's intention or preference, the driver's trust in the control device may be increased. Since the driver does not need to adjust the cruising speed when encountering the same or similar scenario, the fatigue and stress of the driver may be reduced, and a relaxed driving experience may be obtained. In this way, the driver will also be willing to continuously enable ACC to assist driving and improve overall driving safety.

In order to make the above-mentioned features and advantages of the present disclosure more comprehensible, the following specific embodiments are given and described in detail with reference to the accompanying drawings as follows.

### BRIEF DESCRIPTION OF THE DRAWINGS

FIG. 1 is a schematic view showing a driver's vehicle and a preceding vehicle according to an embodiment of the present disclosure.

FIG. 2 is a schematic block view showing a vehicle control device according to an embodiment of the present disclosure.

FIG. 3A and FIG. 3B show an example of vehicle control according to an embodiment of the present disclosure.

FIG. 4 shows another example of vehicle control according to an embodiment of the present disclosure.

FIG. 5 shows still another example of vehicle control according to an embodiment of the present disclosure.

FIG. 6 shows yet another example of vehicle control according to an embodiment of the present disclosure.

FIG. 7A and FIG. 7B show an example of vehicle control according to an embodiment of the present disclosure.

FIG. 8 is a flowchart showing the steps of a vehicle control method according to an embodiment of the present disclosure.

### DESCRIPTION OF THE EMBODIMENTS

Reference will now be made in detail to the exemplary embodiments of the present disclosure, examples of which are illustrated in the accompanying drawings. Wherever possible, the same reference numerals are used in the drawings and description to refer to the same or like parts.

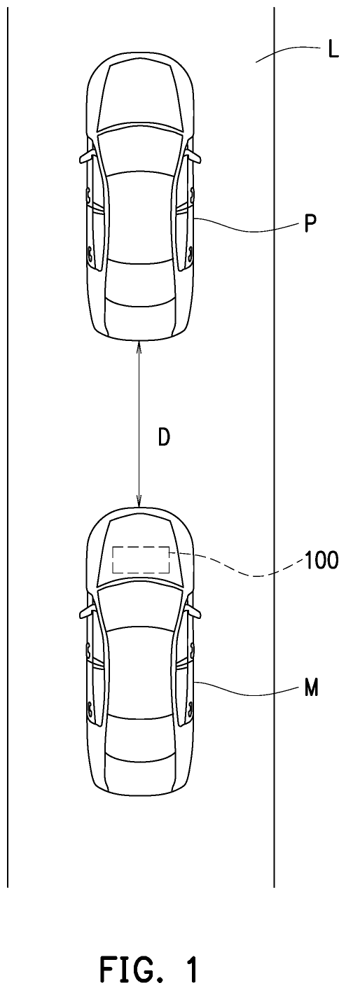

FIG. 1 is a schematic view showing a driver's vehicle and a preceding vehicle according to an embodiment of the present disclosure. As shown in FIG. 1, on the lane L, the driver's vehicle M is positioned behind the preceding vehicle P by a vehicle distance D. The driver's vehicle M and the preceding vehicle P are, for example, two-wheeled, three-wheeled, or four-wheeled vehicles, including vehicles using an internal combustion engine such as a diesel engine or a gasoline engine as a power source, electric vehicles using an electric motor as a power source, and hybrid vehicles using an internal combustion engine combined with an electric motor, etc. Electric vehicles are, for example, driven using electric power discharged from batteries such as secondary batteries, hydrogen fuel cells, metal fuel cells, and alcohol fuel cells. In addition, although the lane L in FIG. 1 appears to be a straight lane, the present disclosure is not limited thereto, and the lane L may also be a curved curve with any curvature conforming to road regulations.

In FIG. 1, the vehicle control device 100 is arranged on the driver's vehicle M, and controls the driving of the driver's vehicle M. The components and control method of the vehicle control device 100 will be described below.

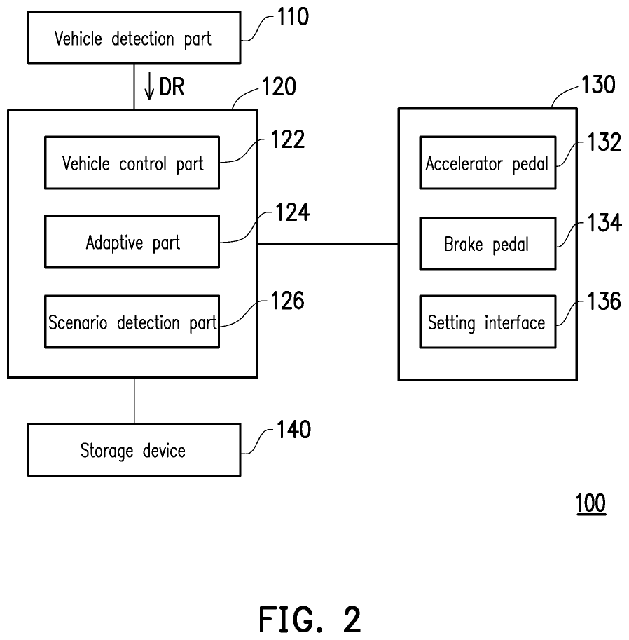

FIG. 2 is a schematic block view showing a vehicle control device according to an embodiment of the present disclosure. Please refer to FIG. 1 and FIG. 2 both, the vehicle control device 100 includes a vehicle detection part 110, a control part 120, an input part 130 and a storage device 140. The vehicle detection part 110 includes, for example, one or more cameras, Radio Detection and Ranging (radar), Light Detection and Ranging (lidar), and devices required for the Vehicle-to-everything (V2X). In this embodiment, the vehicle detection part 110 is configured to detect vehicles (e.g., the preceding vehicle P) existing around the driver's vehicle M, and output the detection result DR to the control part 120.

The control part 120 is coupled to the vehicle detection part 110. As shown in FIG. 2, the control part 120 includes a vehicle control part 122, an adaptive part 124, and a scenario detection part 126. Part or all of the control part 120 may be realized by a processor executing a program (software). Moreover, some or all of them may also be implemented by hardware such as a Large Scale Integration (LSI) or an Application Specific Integrated Circuit (ASIC), and may also be implemented by a combination of software and hardware.

The input part 130 is coupled to the control part 120. As shown in FIG. 2, the input part 130 includes an accelerator pedal 132, a brake pedal 134 and a setting interface 136. The setting interface 136 is, for example, a human machine interface (HMI) for a vehicle, which may, for example, allow the driver of the driver's vehicle M to adjust the set speed (cruising speed) of the adaptive cruise control (ACC) and the target vehicle distance to the preceding vehicle P.

The storage device 140 is coupled to the control part 120. The storage device 140 is configured to store data such as the history of acceleration/deceleration instructions and the execution program, which may be, for example, any type of fixed or removable random access memory (RAM), read-only memory (ROM), flash memory, hard disk or other similar devices, integrated circuits and combinations thereof.

In the present embodiment, the vehicle control part 122 in the control part 120 is configured to execute ACC on the driver's vehicle M, for example, and may control the vehicle distance to the preceding vehicle P based on the detection result DR.

The adaptive part 124 may use an adaptation algorithm to accelerate/decelerate the driver's vehicle M according to the acceleration/deceleration instruction from the driver when the vehicle control part 122 is executing the control of the vehicle distance to the preceding vehicle P (that is, when the ACC is executed on the driver's vehicle M). Specifically, in the present embodiment, when the driver steps on the accelerator pedal 132 or steps on the brake pedal 134 while ACC is executed on the driver's vehicle M, the vehicle control part 122 does not deactivate the ACC. Meanwhile, the adaptive part 124 may obtain the acceleration/deceleration instruction from the driver according to the change of the position of the accelerator pedal 132, the change of the position of the brake pedal 134 or the setting operation received from the setting interface 136. Furthermore, the adaptive part 124 may calculate the preferred acceleration/deceleration characteristics of the driver of the driver's vehicle M according to the acceleration/deceleration instructions when the driver of the driver's vehicle M executes ACC under the current scenario, and change the vehicle acceleration/deceleration characteristics of the driver's vehicle M for actual driving based on the preferred acceleration/deceleration characteristics. The preferred acceleration/deceleration characteristics include, for example, the set speed (cruising speed) of the ACC preferred by the driver in the current scenario and the target vehicle distance to the preceding vehicle P. The vehicle acceleration/deceleration characteristics include, for example, the set speed (cruising speed) used by the driver's vehicle M for actual driving in the current scenario and the target vehicle distance to the preceding vehicle P. In this embodiment, the current scenario may represent data that defines the current driving environment of the driver's vehicle M, for example, including one or more of the corner radius parameter of the lane, the target vehicle parameter (for example, whether there is a vehicle ahead), the speed limit parameter of the lane, the road condition parameter of the lane, and the lane width parameter of the lane. For example, the above parameters may include any values that can define different scenarios, such as corner radius, target vehicle distance, road type, lane width, vehicle speed limit, number of surrounding targets, type of surrounding target, surrounding target speed or trajectory, distance to surrounding targets, road tire friction level, the amount of rain or snow, ambient brightness, time, location, the number of drivers in the vehicle, the identity of the driver, and the like.

Based on the above, the adaptive part 124 may instantly change the set speed of the ACC and the target vehicle distance to the preceding vehicle P based on the acceleration/deceleration instructions of the driver in the current scenario, so as to accelerate/decelerate the driver's vehicle M.

In an embodiment, when the calculated preferred acceleration/deceleration characteristics exceed a safe range applicable to the current scenario, the adaptive part 124 may suspend changing the vehicle acceleration/deceleration characteristics based on the preferred acceleration/deceleration characteristics to avoid danger to the driver's vehicle M. For example, the safe range includes the safe range of any numerical parameters taken into consideration for driving safety, such as the speed limit of the lane, the driving speed generated according to the preferred acceleration/deceleration characteristics being greater than or equal to 7 m/s, lateral acceleration being less than or equal to 2.3 m/s², longitudinal acceleration being less than or equal to 2 m/s², and the average deceleration being less than or equal to −3.5 m/s², etc.

In addition, when the driver's vehicle M is in the same or similar scenario again, the adaptive part 124 may also change the vehicle acceleration/deceleration characteristics of the driver's vehicle M in the control of the vehicle distance (i.e., when ACC is executed on the driver's vehicle M) based on the history of acceleration/deceleration instructions in the past.

Specifically, the storage device 140 in the vehicle control device 100 may store the history of the acceleration/deceleration instructions. The history of acceleration/deceleration instructions is constructed based on the driver's preferred acceleration/deceleration characteristics in various scenarios recorded in the past. In this embodiment, the history of the acceleration/deceleration instructions includes multiple reference scenarios and multiple reference acceleration/deceleration characteristics respectively associated with the multiple reference scenarios.

Table 1 shows the history of acceleration/deceleration instructions according to an embodiment of the present disclosure. In Table 1, the reference acceleration/deceleration characteristics C1 to C4 are associated with reference scenarios S1 to S4, respectively. Each of the reference acceleration/deceleration characteristics C1 to C4 includes a set speed and a target vehicle distance corresponding to the associated reference scenario.

TABLE 1

| | |
|---|---|
| Reference | Reference acceleration/deceleration |
| scenario S1 | characteristic C1 |
| | (set speed = 80 km/h, target vehicle |
| | distance = 2) |
| Reference | Reference acceleration/deceleration |
| scenario S2 | characteristic C2 |
| | (set speed = 100 km/h, target vehicle |
| | distance = 4) |
| Reference | Reference acceleration/deceleration |
| scenario S3 | characteristic C3 |
| | (set speed = 90 km/h, target vehicle |
| | distance = 3) |
| Reference | Reference acceleration/deceleration |
| scenario S4 | characteristic C4 |
| | (set speed = 60 km/h, target vehicle |
| | distance = 1) |

Each of the reference scenarios S1 to S4 may represent data that defines the driving environments experienced by the driver's vehicle M, for example, including one or more of the corner radius parameter of the lane, the target vehicle parameter (for example, whether there is a vehicle ahead), the speed limit parameter of the lane, the road condition parameter of the lane, and the lane width parameter of the lane. For example, the above parameters may include any values that can define different scenarios, such as corner radius, target vehicle distance, road type, lane width, vehicle speed limit, number of surrounding targets, type of surrounding target, surrounding target speed or trajectory, distance to surrounding targets, road tire friction level, the amount of rain or snow, ambient brightness, time, location, the number of drivers in the vehicle, the identity of the driver, and the like.

The unit of the target vehicle distance in the above Table 1 is, for example, the reference vehicle distance. The target vehicle distance=1 means that there is 1 reference vehicle distance to the preceding vehicle P, the target vehicle distance=2 means that there are 2 reference vehicle distances to the preceding vehicle P, the larger the target vehicle distance, the farther the distance to the preceding vehicle P is, and so on. The reference vehicle distance is equal to the vehicle length of the driver's vehicle M, for example. It should be noted that the number of reference scenarios and the numerical values shown in Table 1 above are not intended to limit the present disclosure, and the history of acceleration/deceleration instructions is not limited to the form expressed in Table 1.

The scenario detection part 126 in the control part 120 may detect the current scenario while the driver's vehicle M is driven. The adaptive part 124 may compare the current scenario of the driver's vehicle M with the reference scenarios S1 to S4 stored in the storage device 140. When the current scenario matches one of the reference scenarios S1 to S4, the adaptive part 124 may change the vehicle acceleration/deceleration characteristics of the driver's vehicle M in the control of the vehicle distance (i.e., when ACC is executed on the driver's vehicle M) based on the reference acceleration/deceleration characteristics associated with the matched reference scenario. For example, when various data of the current scenario detected by the scenario detection part 126 are the same as or similar to the reference scenario S1, the adaptive part 124 may change the set speed of the driver's vehicle M to 80 km/h and change the target vehicle distance to 2 in the control of vehicle distance based on the reference acceleration/deceleration characteristic C1 associated with the reference scenario S1. In this way, when the driver's vehicle M encounters the same or similar scenario again as the one it has experienced before, the adaptive part 124 may find a suitable reference acceleration/deceleration characteristic based on the history of the acceleration/deceleration instructions recorded in the past to automatically change the vehicle acceleration/deceleration characteristics of the driver's vehicle M in the control of the vehicle distance.

In addition, when the current scenario of the driver's vehicle M matches one of the reference scenarios S1 to S4, and the adaptive part 124 obtains the acceleration/deceleration instruction from the driver, the adaptive part 124 may update the reference acceleration/deceleration characteristic associated with the matched reference scenario according to the acceleration/deceleration instruction from the driver. For example, when various data of the current scenario detected by the scenario detection part 126 are the same or similar to the reference scenario S3, and the adaptive part 124 has changed the set speed of the driver's vehicle M to 90 km/h and changed the target vehicle distance to 3 in the control of vehicle distance based on the reference acceleration/deceleration characteristic C3 associated with the reference scenario S3, the adaptive part 124 still obtains the acceleration/deceleration instruction from the driver, indicating that the current reference acceleration/deceleration characteristic C3 does not meet the driver's preference. Under the circumstances, the adaptive part 124 not only changes the set speed of the ACC of the driver's vehicle M and the target vehicle distance to the preceding vehicle P in real time based on the acceleration/deceleration instruction of the driver, but also updates the reference acceleration/deceleration characteristic C3 stored in the storage device 140 according to the acceleration/deceleration instruction of the driver. Therefore, when the driver's vehicle M encounters the same or similar scenario again as experienced in the reference scenario S3, the adaptive part 124 may change the vehicle acceleration/deceleration characteristic of the driver's vehicle M based on the updated reference acceleration/deceleration characteristic C3 that conforms to the driver's preference.

When the current scenario of the driver's vehicle M does not match any of the reference scenarios S1 to S4, and the adaptive part 124 obtains the acceleration/deceleration instruction from the driver, the adaptive part 124 may calculate the preferred acceleration/deceleration characteristics of the driver according to the acceleration/deceleration instruction from the driver, and store the current scenario and the preferred acceleration/deceleration characteristic in the storage device 140 as the new reference scenario and reference acceleration/deceleration characteristic.

For example, when various data of the current scenario detected by the scenario detection part 126 do not match any one of the reference scenarios S1 to S4, the adaptive part 124 obtains an acceleration/deceleration instruction from the driver, indicating that the relevant information of the current scenario is not yet stored in the storage device 140. Under the circumstances, the adaptive part 124 not only instantly changes the set speed of the ACC of the driver's vehicle M and the target vehicle distance to the preceding vehicle P based on the acceleration/deceleration instructions of the driver, but also calculates the preferred acceleration/deceleration characteristics of the driver according to the acceleration/deceleration instructions from the driver, and stores the current scenario and the preferred acceleration/deceleration characteristic in the storage device 140 as the new reference scenario and the reference acceleration/deceleration characteristic. Therefore, when the driver's vehicle M encounters the same or similar scenario again as experienced in the new reference scenario, the adaptive part 124 may change the vehicle acceleration/deceleration characteristic of the driver's vehicle M based on the new reference acceleration/deceleration characteristic that conforms to the driver's preference.

Several examples are given below to illustrate the operation mode of the vehicle control of the present disclosure. It should be noted that the recitation “after adaptation” in the following embodiments refers to operation of the history of acceleration/deceleration instructions stored in the storage device 140 after the above-mentioned adaptive part 124 updates or adds new reference acceleration/deceleration characteristics to the storage device 140.

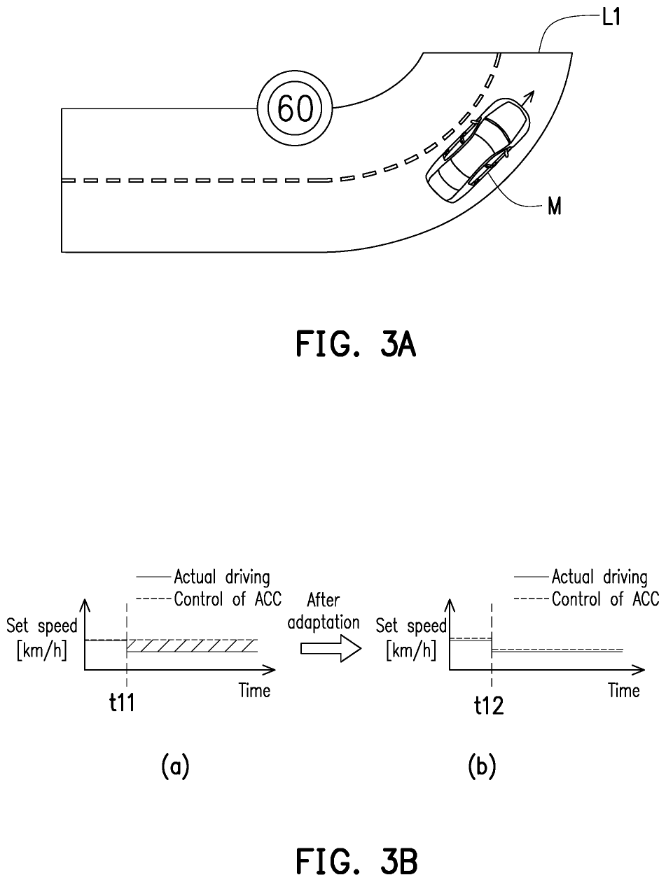

FIG. 3A and FIG. 3B show an example of vehicle control according to an embodiment of the present disclosure. Please refer to FIG. 3A and FIG. 3B. In this example, when the driver's vehicle M is driving in a lane L1 with a first speed limit (e.g., a speed limit of 60 km/h), the driver's vehicle M approaches a curve when ACC is executed. Since the driver wants to reduce the speed of the driver's vehicle M in the curve, the set speed may be reduced (for example, reduced from 60 km/h to 55 km/h) through the setting interface 136. Under the circumstances, as shown in (a) of FIG. 3B, the adaptive part 124 may change the vehicle acceleration/deceleration characteristic of the driver's vehicle M in actual driving at the time point t11 based on the preferred acceleration/deceleration characteristic, i.e., the set speed of 55 km/h. Therefore, in (a) of FIG. 3B, the solid line representing the acceleration at which the driver's vehicle M is actually driven is lower than the dashed line representing the driver's vehicle M under the control of only ACC after the time point t11.

After adaptation, as shown in (b) of FIG. 3B, when the driver's vehicle M approaches the same or similar curve (scenario) again, the adaptive part 124 may find the associated reference acceleration/deceleration characteristic with the set speed of 55 km/h based on the history of previously recorded acceleration/deceleration instruction at time point t12, thereby automatically changing the acceleration/deceleration characteristic of the driver's vehicle M. Therefore, in (b) of FIG. 3B, since the driver no longer changes the set speed, the solid line representing the acceleration at which the driver's vehicle M is actually driven conforms to the dashed line representing the driver's vehicle M under the control of only ACC after the time point t12, which shows that the ACC control is in line with the driver's preference in actual driving.

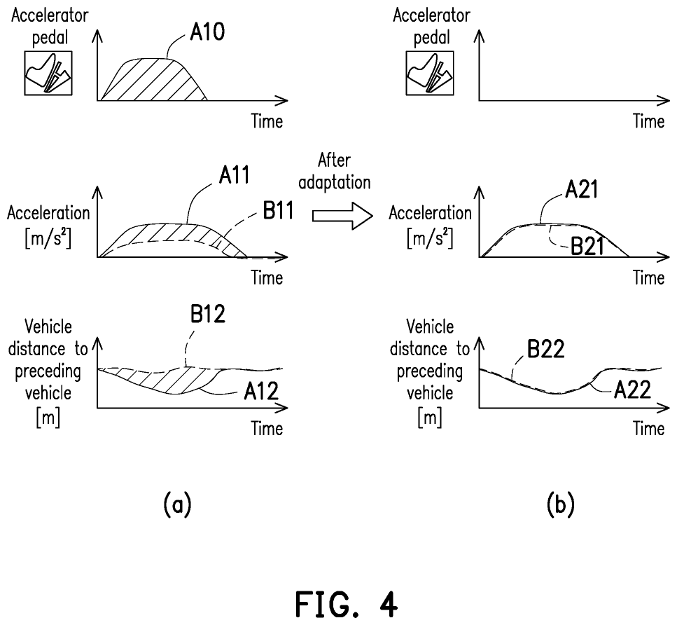

FIG. 4 shows an example of vehicle control according to an embodiment of the present disclosure. Please refer to FIG. 4, in this example, (a) of FIG. 4 represents the initial situation before the adaption is performed, that is, the situation where the storage device 140 does not store the history of the acceleration/deceleration instruction; (b) of FIG. 4 shows the situation after the adaptation is performed. The upper parts of (a) and (b) of FIG. 4 show the relationship of the accelerator pedal 132 with respect to time, the middle parts of (a) and (b) of FIG. 4 show the relationship of the acceleration of the driver's vehicle M with respect to time, and the lower parts of (a) and (b) of FIG. 4 show the relationship of the vehicle distance between the driver's vehicle M and the preceding vehicle P with respect to time.

In the current scenario, as shown in (a) of FIG. 4, the driver steps on the accelerator pedal 132 in order to increase the speed of the driver's vehicle M during the execution of ACC. Therefore, a waveform A10 representing the change in the position of the accelerator pedal 132 is shown in the relationship diagram at the upper part of (a) of FIG. 4. Meanwhile, in the relationship diagram shown at the middle part of (a) of FIG. 4, the waveform A11 illustrated in solid line and representing the acceleration curve of the driver's vehicle M in actual driving is higher than the waveform B11 illustrated in dashed line and representing the acceleration curve of the driver's vehicle M under the control of only ACC in a partial time interval. In the relationship diagram at the lower part of (a) of FIG. 4, a waveform A12 illustrated in solid line and representing the variation curve of the vehicle distance between the driver's vehicle M and the preceding vehicle P in actual driving is lower than a waveform B11 illustrated in dashed line and representing the variation curve of the vehicle distance between the driver's vehicle M and the preceding vehicle P under the control of only ACC in a partial time interval, which shows that the control of the ACC has not yet met the driver's preference for actual driving.

After the adaptation is performed, as shown in (b) of FIG. 4, when the driver's vehicle M is in the same or similar scenario again, the driver's vehicle M under the control of the ACC will automatically increase the speed of the driver's vehicle M according to the driver's preference, so that the acceleration of the driver's vehicle M and the vehicle distance to the preceding vehicle P conform to the driver's preference. Therefore, the driver will not want to step on the accelerator pedal 132, and the relationship diagram at the upper part of (b) of FIG. 4 will not show any waveform representing a change in the position of the accelerator pedal 132. Meanwhile, in the relationship diagram at the middle part of (b) of FIG. 4, the waveform A21 illustrated in solid line and representing the acceleration curve of the driver's vehicle M in actual driving will conform to the waveform B21 illustrated in dashed line and representing the acceleration curve of the driver's vehicle M under the control of only ACC. In the relationship diagram at the lower part of (b) of FIG. 4, a waveform A22 illustrated in solid line and representing the variation curve of the vehicle distance between the driver's vehicle M and the preceding vehicle P in actual driving will conform to a waveform B22 illustrated in dashed line and representing the variation curve of the vehicle distance between the driver's vehicle M and the preceding vehicle P under the control of only ACC. Accordingly, when the driver's vehicle M encounters the same or similar scenario again as the one experienced before, the adaptive part 124 can find a suitable reference acceleration/deceleration characteristics based on the history of the previously recorded acceleration/deceleration instructions, so as to automatically change the vehicle acceleration/deceleration characteristics of the driver's vehicle M during the control of the vehicle distance (when ACC is performed on the driver's vehicle M) to adapt to the driver's preference.

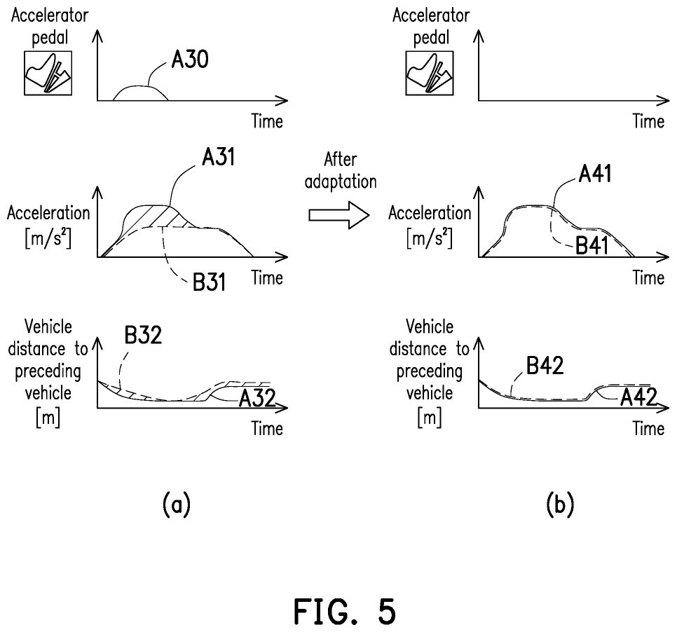

FIG. 5 shows still another example of vehicle control according to an embodiment of the present disclosure. Referring to FIG. 5, in this example, after the adaptation described in the embodiment of FIG. 4 is performed, the adaptive part 124 performs the adaptation again. In FIG. 5, (a) shows the case where the adaptation described in FIG. 4 has been executed, that is, the storage device 140 has stored the history of the acceleration/deceleration instruction for the adaptation described in FIG. 4; (b) of FIG. 5 shows the scenario after the adaptation is performed again. The upper parts of (a) and (b) of FIG. 5 show the relationship of the accelerator pedal 132 with respect to time, the middle parts of (a) and (b) of FIG. 5 show the relationship of the acceleration of the driver's vehicle M with respect to time, and the lower parts of (a) and (b) of FIG. 5 show the relationship of the vehicle distance between the driver's vehicle M and the preceding vehicle P with respect to time.

After the adaptation described in the embodiment of FIG. 4 is performed and the same scenario as described in the embodiment of FIG. 4 is encountered again, the adaptive part 124 may automatically change the vehicle acceleration/deceleration characteristics of the driver's vehicle M in the control of vehicle distance (when ACC is performed on the driver's vehicle M) based on the acceleration/deceleration instructions of the driver in FIG. 4. Therefore, the waveform B31 illustrated in dashed line in the relationship diagram at the middle part of (a) of FIG. 5 and representing the acceleration curve of the driver's vehicle M under the control of only ACC will be equal to the waveform B21 illustrated in dashed line in the relationship diagram at the middle part of (b) of FIG. 4. The waveform B32 illustrated in dashed line in the relationship diagram at the lower part of (a) of FIG. 5 and representing the variation curve of vehicle distance between the driver's vehicle M and the preceding vehicle P under the control of only ACC will be equal to the waveform B22 illustrated in dashed line in the relationship diagram at the lower part of (b) of FIG. 4.

However, as shown in (a) of FIG. 5, the driver steps on the accelerator pedal 132 again to increase the speed of the driver's vehicle M while the ACC is being executed. Therefore, a waveform A30 representing the change in the position of the accelerator pedal 132 is shown in the relationship diagram at the upper part of (a) of FIG. 5. Meanwhile, in the relationship diagram shown at the middle part of (a) of FIG. 5, the waveform A31 illustrated in solid line and representing the acceleration curve of the driver's vehicle M in actual driving is higher than the waveform B31 illustrated in dashed line and representing the acceleration curve of the driver's vehicle M under the control of only ACC in a partial time interval. In the relationship diagram at the lower part of (a) of FIG. 5, a waveform A32 illustrated in solid line and representing the variation curve of the vehicle distance between the driver's vehicle M and the preceding vehicle P in actual driving is lower than a waveform B31 illustrated in dashed line and representing the variation curve of the vehicle distance between the driver's vehicle M and the preceding vehicle P under the control of only ACC in a partial time interval, which shows that the control of the ACC has not yet met the driver's preference for actual driving.

After the adaptation is performed, as shown in (b) of FIG. 5, when the driver's vehicle M is in the same or similar scenario again, the driver's vehicle M under the control of the ACC will automatically increase the speed of the driver's vehicle M according to the driver's preference, so that the acceleration of the driver's vehicle M and the vehicle distance to the preceding vehicle P conform to the driver's preference. Therefore, the driver will not want to step on the accelerator pedal 132, and the relationship diagram at the upper part of (b) of FIG. 5 will not show any waveform representing a change in the position of the accelerator pedal 132. Meanwhile, in the relationship diagram at the middle part of (b) of FIG. 5, the waveform A41 illustrated in solid line and representing the acceleration curve of the driver's vehicle M in actual driving will conform to the waveform B41 illustrated in dashed line and representing the acceleration curve of the driver's vehicle M under the control of only ACC. In the relationship diagram at the lower part of (b) of FIG. 5, a waveform A42 illustrated in solid line and representing the variation curve of the vehicle distance between the driver's vehicle M and the preceding vehicle P in actual driving will conform to a waveform B42 illustrated in dashed line and representing the variation curve of the vehicle distance between the driver's vehicle M and the preceding vehicle P under the control of only ACC. Accordingly, when the driver's vehicle M encounters the same or similar scenario again as the one experienced before, the adaptive part 124 can find a suitable reference acceleration/deceleration characteristics based on the history of the previously recorded acceleration/deceleration instructions, so as to automatically change the vehicle acceleration/deceleration characteristics of the driver's vehicle M during the control of the vehicle distance (when ACC is performed on the driver's vehicle M) to adapt to the driver's preference.

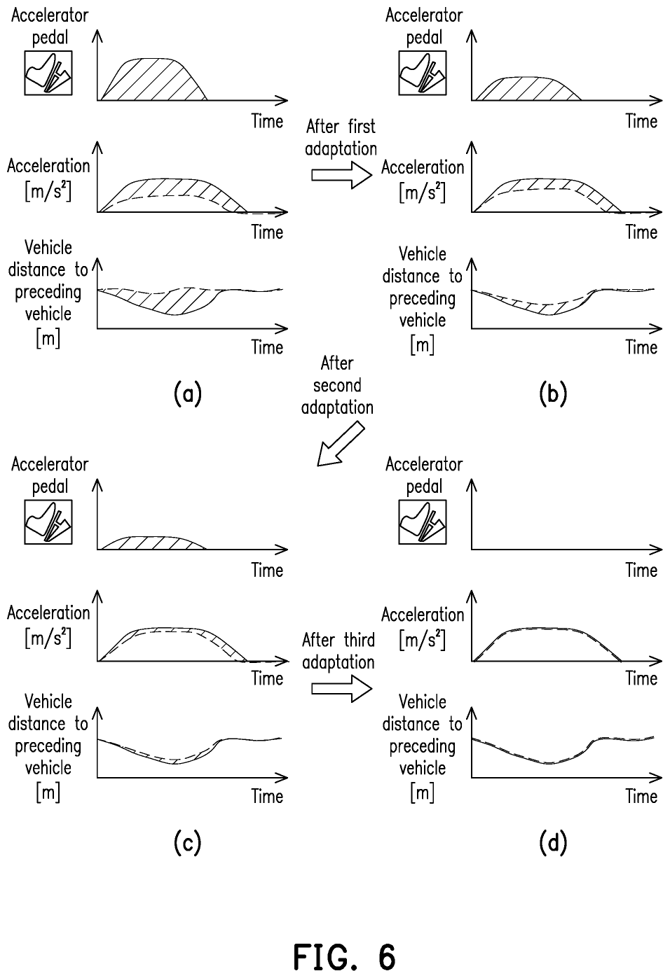

FIG. 6 shows yet another example of vehicle control according to an embodiment of the present disclosure. Please refer to FIG. 6, in this example, (a) of FIG. 6 represents the initial situation before the adaption is performed, that is, the situation where the storage device 140 does not store the history of the acceleration/deceleration instruction; (b) of FIG. 6 shows the situation after the adaptation is performed for the first time; (c) of FIG. 6 shows the situation after the adaptation is performed for the second time; and (d) of FIG. 6 shows the situation after the adaptation is performed for the third time. Similarly, (a) to (d) of FIG. 6 respectively show the relationship of the accelerator pedal 132 with respect to time, the relationship of the acceleration of the driver's vehicle M with respect to time, and the relationship of the vehicle distance between the driver's vehicle M and the preceding vehicle P with respect to time. Similar to the foregoing embodiment, in (a) to (d) of FIG. 6, the waveforms illustrated in solid line at the upper, middle, and lower parts respectively represent the change in the position of the accelerator pedal 132 of the driver's vehicle M, the acceleration curve, and a variation curve of the vehicle distance to the preceding vehicle P in actual driving, and the waveforms illustrated in dashed line at the upper, middle, and lower parts respectively represent the change in the position of the accelerator pedal 132 of the driver's vehicle M, the acceleration curve, and a variation curve of the vehicle distance to the preceding vehicle P under the control of only ACC. However, different from the previous embodiment, although the driver's vehicle M under the control of the ACC will automatically increase the speed of the driver's vehicle M according to the driver's preference, in this embodiment, the range of speed increase at one time is limited. Therefore, it is necessary to repeat the adaptation multiple times, and the vehicle acceleration/deceleration characteristics of the driver's vehicle M shown in (d) of FIG. 6 will conform to the driver's preference after the adaptation is performed for the third time.

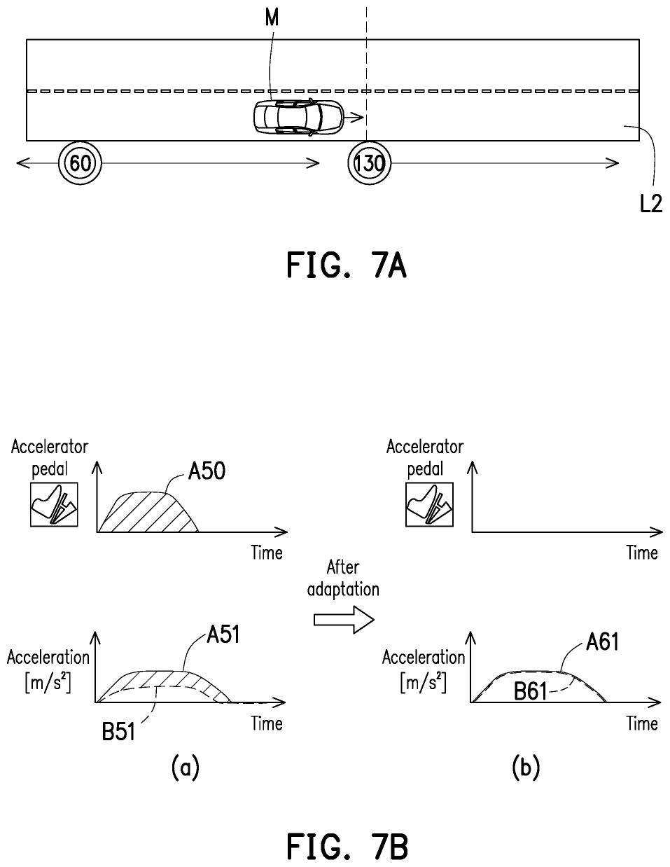

FIG. 7A and FIG. 7B show an example of vehicle control according to an embodiment of the present disclosure. Referring to FIG. 7A and FIG. 7B, in this example, the driver's vehicle M is driven on a lane L2 having two sections with a first speed limit (e.g., a speed limit of 60 km/h) and a second speed limit (e.g., a speed limit of 130 km/h). As shown in FIG. 7A, when the driver's vehicle M enters the section with the second speed limit from the section with the first speed limit, since the driver wants to increase the speed of the driver's vehicle M, the driver steps on the accelerator pedal 132 to increase the speed of the driver's vehicle M (e.g., from 60 km/h to 130 km/h). Under the circumstances, as shown in (a) of FIG. 7B, a waveform A50 indicating a change in the position of the accelerator pedal 132 is show at the upper part of (a) of FIG. 7B. Meanwhile, in the relationship diagram at the lower part of (a) of FIG. 7B, the waveform A51 illustrated in solid line and representing the acceleration curve of the driver's vehicle M in actual driving is higher than the waveform B51 illustrated in dashed line and representing the acceleration curve of the driver's vehicle M under the control of only ACC in a partial time interval.

After the adaptation is performed, as shown in (b) of FIG. 7B, when the driver's vehicle M is driven on the same or similar road (scenario) again, the driver's vehicle M under the control of the ACC will automatically increase the speed of the driver's vehicle M according to the driver's preference. Therefore, the driver will not want to step on the accelerator pedal 132, and the relationship diagram at the upper part of (b) of FIG. 7B will not show any waveform representing a change in the position of the accelerator pedal 132. Meanwhile, in the relationship diagram at the lower part of (b) of FIG. 7B, the waveform A61 illustrated in solid line and representing the acceleration curve of the driver's vehicle M in actual driving will conform to the waveform B61 illustrated in dashed line and representing the acceleration curve of the driver's vehicle M under the control of only ACC. Accordingly, when the driver's vehicle M encounters the same or similar scenario again as the one experienced before, the adaptive part 124 can find a suitable reference acceleration/deceleration characteristics based on the history of the previously recorded acceleration/deceleration instructions, so as to automatically change the vehicle acceleration/deceleration characteristics of the driver's vehicle M during the control of the vehicle distance (when ACC is performed on the driver's vehicle M) to adapt to the driver's preference.

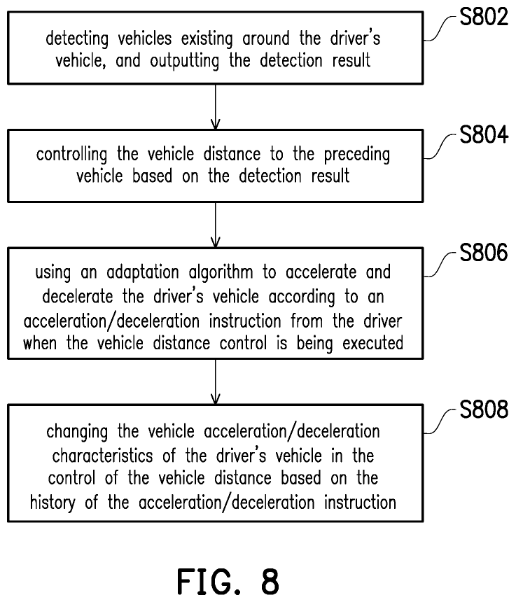

FIG. 8 is a flowchart showing the steps of a vehicle control method according to an embodiment of the present disclosure. Referring to FIG. 8, the vehicle control method in this embodiment includes the following steps: detecting vehicles existing around the driver's vehicle, and outputting the detection result (step S802); next, controlling the vehicle distance to the preceding vehicle based on the detection result (step S804); then, using an adaptation algorithm to accelerate/decelerate the driver's vehicle according to an acceleration/deceleration instruction from the driver when the vehicle distance control is being executed (step S806); finally, changing the vehicle acceleration/deceleration characteristics of the driver's vehicle in the control of the vehicle distance based on the history of the acceleration/deceleration instruction (step S808). The details of the above steps S802, S804, S806 and S808 may be referred to the embodiments of FIG. 1 to FIG. 7A and FIG. 7B, which will not be repeated here.

To sum up, the vehicle control device and method of the present disclosure may change the vehicle acceleration/deceleration characteristics of the driver's vehicle in a specific scenario based on the history of acceleration/deceleration instructions of the driver during the ACC activation period. In the meantime, the driver may also give acceleration/deceleration instructions, so that the driver's vehicle may accelerate/decelerate in real time under the control of ACC. The driver's preferences are also updated to the storage device for use in the same or similar scenario encountered next time. In this way, not only that the driver's trust in the control device may be increased, but also the fatigue and stress of the driver may be reduced, and the driver will also be willing to continuously enable ACC to assist driving and improve overall driving safety.

Finally, it should be noted that the above embodiments are only used to illustrate the technical solutions of the present disclosure, but not to limit them. Although the present disclosure has been described in detail with reference to the foregoing embodiments, those of ordinary skill in the art should understand that: The technical solutions described in the foregoing embodiments can still be modified, or some or all of the technical features thereof can be equivalently replaced; and these modifications or replacements do not make the essence of the corresponding technical solutions deviate from the scope of technical solutions of the embodiments of the present disclosure.

What is claimed is:

1. A vehicle control device, comprising:
a vehicle detection part, which detects vehicles existing around a driver's vehicle and outputs a detection result; and
a control part coupled to the vehicle detection part, wherein the control part comprises:
a vehicle control part, which controls a vehicle distance to a preceding vehicle based on the detection result; and
an adaptive part, which uses an adaptation algorithm to accelerate/decelerate the driver's vehicle according to an acceleration/deceleration instruction from the driver when the vehicle control part is executing control of the vehicle distance,
wherein the adaptive part changes a vehicle acceleration/deceleration characteristic of the driver's vehicle in the control of the vehicle distance based on a history of the acceleration/deceleration instruction.

2. The vehicle control device according to claim 1, wherein
the vehicle control device further comprises:
an input part coupled to the control part, wherein the input part comprises an accelerator pedal, a brake pedal, and a setting interface,
the adaptive part obtains the acceleration/deceleration instruction from the driver according to a change of a position of the accelerator pedal, a change of a position of the brake pedal, or a setting operation received from the setting interface.

3. The vehicle control device according to claim 1, wherein
the vehicle acceleration/deceleration characteristic comprises a set speed for adaptive cruise control and a target vehicle distance to the preceding vehicle.

4. The vehicle control device according to claim 1, wherein
the adaptive part calculates a preferred acceleration/deceleration characteristic of the driver according to the acceleration/deceleration instruction from the driver, and changes the vehicle acceleration/deceleration characteristic based on the calculated preferred acceleration/deceleration characteristic to accelerate/decelerate the driver's vehicle.

5. The vehicle control device according to claim 4, wherein
when the calculated preferred acceleration/deceleration characteristic exceeds a safe range, the adaptive part suspends changing the vehicle acceleration/deceleration characteristic based on the preferred acceleration/deceleration characteristic.

6. The vehicle control device according to claim 1, wherein
the vehicle control device further comprises:
a storage device coupled to the control part and storing the history of the acceleration/deceleration instruction,
wherein the history of the acceleration/deceleration instruction comprises a plurality of reference scenarios and a plurality of reference acceleration/deceleration characteristics respectively associated with the plurality of reference scenarios.

7. The vehicle control device according to claim 6, wherein
each of the reference scenarios comprises one or more of a corner radius parameter, a target vehicle parameter, a speed limit parameter, a road condition parameter, and a lane width parameter.

8. The vehicle control device according to claim 6, wherein the control part further comprises:
a scenario detection part, which detects a current scenario while the driver's vehicle is driven,
wherein the adaptive part compares the current scenario of the driver's vehicle with the plurality of reference scenarios stored in the storage device,
when the current scenario matches one of the plurality of reference scenarios, the adaptive part changes the vehicle acceleration/deceleration characteristic of the driver's vehicle in the control of the vehicle distance based on the reference acceleration/deceleration characteristic associated with the one of the plurality of reference scenarios.

9. The vehicle control device according to claim 8, wherein
when the current scenario matches the one of the plurality of reference scenarios, and the adaptive part obtains the acceleration/deceleration instruction from the driver, the adaptive part updates the reference acceleration/deceleration characteristic associated with the one of the plurality of reference scenarios according to the acceleration/deceleration instruction from the driver.

10. The vehicle control device according to claim 8, wherein
when the current scenario does not match any one of the plurality of reference scenarios, and the adaptive part obtains the acceleration/deceleration instruction from the driver, the adaptive part calculates a preferred acceleration/deceleration characteristic of the driver according to the acceleration/deceleration instruction from the driver, and stores the current scenario and the preferred acceleration/deceleration characteristic in the storage device as a new reference scenario and a new reference acceleration/deceleration characteristic.

11. A vehicle control method, comprising the following steps:
detecting vehicles existing around a driver's vehicle and outputting a detection result;
controlling a vehicle distance to a preceding vehicle based on the detection result;
using an adaptation algorithm to accelerate/decelerate the driver's vehicle according to an acceleration/deceleration instruction from the driver when executing control of the vehicle distance; and
changing a vehicle acceleration/deceleration characteristic of the driver's vehicle in the control of the vehicle distance based on a history of the acceleration/deceleration instruction.

12. The vehicle control method according to claim 11, further comprising:
obtaining the acceleration/deceleration instruction from the driver according to a change of a position of an accelerator pedal, a change of a position of a brake pedal, or a setting operation received from a setting interface.

13. The vehicle control method according to claim 11, wherein
the vehicle acceleration/deceleration characteristic comprises a set speed for adaptive cruise control and a target vehicle distance to the preceding vehicle.

14. The vehicle control method according to claim 11, wherein the step of accelerating/decelerating the driver's vehicle according to the acceleration/deceleration instruction from the driver comprises:
calculating a preferred acceleration/deceleration characteristic of the driver according to the acceleration/deceleration instruction from the driver; and
changing the vehicle acceleration/deceleration characteristic based on the calculated preferred acceleration/deceleration characteristic to accelerate/decelerate the driver's vehicle.

15. The vehicle control method according to claim 14, further comprising:
when the calculated preferred acceleration/deceleration characteristic exceeds a safe range, suspending changing the vehicle acceleration/deceleration characteristic based on the preferred acceleration/deceleration characteristic.

16. The vehicle control method according to claim 11, further comprising:
storing a history of the acceleration/deceleration instruction,
wherein the history of the acceleration/deceleration instruction comprises a plurality of reference scenarios and a plurality of reference acceleration/deceleration characteristics respectively associated with the plurality of reference scenarios.

17. The vehicle control method according to claim 16, wherein
each of the reference scenarios comprises one or more of a corner radius parameter, a target vehicle parameter, a speed limit parameter, a road condition parameter, and a lane width parameter.

18. The vehicle control method according to claim 16, wherein the step of changing the acceleration/deceleration characteristic of the driver's vehicle in the control of the vehicle distance based on the history of the acceleration/deceleration instruction comprises:
detecting a current scenario while the driver's vehicle is driven;
comparing the current scenario of the driver's vehicle with the plurality of stored reference scenarios; and
when the current scenario matches one of the plurality of reference scenarios, changing the vehicle acceleration/deceleration characteristic of the driver's vehicle in the control of the vehicle distance based on the reference acceleration/deceleration characteristic associated with the one of the plurality of reference scenarios.

19. The vehicle control method according to claim 18, further comprising:
when the current scenario matches the one of the plurality of reference scenarios, and the acceleration/deceleration instruction is obtained from the driver, updating the reference acceleration/deceleration characteristic associated with the one of the plurality of reference scenarios according to the acceleration/deceleration instruction from the driver.

20. The vehicle control method according to claim 18, further comprising:
when the current scenario does not match any one of the plurality of reference scenarios, and the acceleration/deceleration instruction is obtained from the driver, calculating a preferred acceleration/deceleration characteristic of the driver according to the acceleration/deceleration instruction from the driver, and storing the current scenario and the preferred acceleration/deceleration characteristic as a new reference scenario and a new reference acceleration/deceleration characteristic.
